(19) United States
(12) Patent Application Publication
(10) Pub. No.: US 2024/0257598 A1
(43) Pub. Date: Aug. 1, 2024

(54) METHOD AND SYSTEM OF TOUCH-FREE VENDING

(71) Applicant: PepsiCo, Inc., Purchase, NY (US)

(72) Inventors: Igor SHTURMA, Sunnyvale, CA (US); Sasha SHTURMA, San Jose, CA (US)

(21) Appl. No.: 18/633,732

(22) Filed: Apr. 12, 2024

Related U.S. Application Data
(63) Continuation of application No. 17/364,800, filed on Jun. 30, 2021, now Pat. No. 11,961,373.
(60) Provisional application No. 63/047,047, filed on Jul. 1, 2020.

(51) Int. Cl. G07F 9/00; G06Q 20/02; G06Q 20/20; G06Q 20/32; G07F 17/00

(52) U.S. Cl. CPC G07F 9/001; G06Q 20/203; G06Q 20/208; G06Q 20/3274; G06Q 20/027; G07F 17/0014

(57) ABSTRACT

A method and system to access vending machines via a touch-free user interface using a personal electronic device (PED) are described. For each vending session, a unique dynamic tag is generated and presented on a vending machine to be read via a camera. The tag is forwarded by the PED to a remote servicer, which accesses a remote database to determine real-time inventory of the vending machine. This inventory list is transmitted back to the PED for display to a user. The user selects a product from inventory using her PED. This selection is sent to the server, which then transmits instructions to the vending machine to dispense the selected product. The method is free of a requirement for the user to download an app. Security and payment are assured by the use of a unique dynamic tag for each vending session, displayed on or by the vending machine.

### CROSS-REFERENCE TO RELATED APPLICATIONS

This application is a continuation of and claims priority to U.S. application Ser. No. 17/364,800, filed on Jun. 30, 2021. This application claims priority to U.S. Provisional Application No. 63/047,047 filed on Jul. 1, 2020. Each of these applications is incorporated herein in its entirety by reference thereto.

### BACKGROUND OF THE INVENTION

Different sorts of vending and self-service machines can be found in public spaces all around the world. Those are snack and beverage vending machines, ATMs, gas pumps, transit payment kiosks, and others. Traditionally these machines provide a user interface in the form of pushbuttons and a display of some kind. These interfaces are very constrained, not always intuitive, and do not provide users much extra information about the products or services offered by the machine. Another growing concern is that publicly available machines are not regularly cleaned, and the surface of their controls facilitates the spread of pathogen bacteria and viruses. The adoption of interactive screens with touch input in newer machines improves the situation. They are easier to clean and also capable of presenting additional information and better on-screen instructions. Still, more and more people would prefer to interact with public machines and make payments using their personal mobile electronic devices, such as smartphones or tablets.

Many methods exist to accomplish this goal. Typically, they require the user to install an associated application, or “app,” to their device. The application then leverages a connectivity technology such as direct short-range wireless networking, typically Bluetooth or Wi-Fi, a Near-Field Communication (NFC), or remote access over the internet.

These methods have multiple weaknesses. First, installing a dedicated app for a single-time interaction with a public machine is a significant inconvenience. Apps take space, clutter devices, affect their performance, and often annoy users with marketing notifications. For those reasons, the requirement to install an app can be seen as an obstacle to the adoption of the technology. Another problem is that the user's functional proximity to the machine is hard to verify. With remote access and wireless communications, users may initiate actions while not being physically present near the machine (proximal). At the minimum, it can be a source of confusion if several people are competing to access a single machine. In some cases, that is also a security concern. A technique known as geofencing is used to address this, but it relies on a positioning technology unreliable in covered spaces, especially in multi-story buildings. Identification of the machine can also be a problem when multiple machines are located close to each other, which is common for vending machines and laundry machines. When using a remote vending controller or interface, disambiguation of both users and vending machine is critical, which is difficult or reliably impossible with current technology.

### SUMMARY OF THE INVENTION

Embodiments of the invention overcome weaknesses of the prior art. Described embodiments, scenarios, examples, and drawings are non-limiting.

In embodiments of the present disclosure, the identification of the machine and verification of the functional physical proximity is made through manually reading dynamically generated information from a tag generator with a mobile electronic device. Typically, a particular user of a particular vending machine stands in front of the machine, at a suitable distance from the machine, for a smartphone, or similar device, to read, with its camera, a dynamically generated QR code, or other machine readable code, on a display of the particular vending machine. In this way, both the particular user is disambiguated from other users, and the particular vending machine is disambiguated from other vending machines.

The information from the tag generator is then used to direct the user to a web page provided by a server. The page presents a control and payment interface for the user to interact with. As a result of user selections, after the payment is processed, the server generates requests and transmits them to the machine to dispense a product or render a service.

The tag generator in this disclosure is a device capable of generating and communicating a Uniform Resource Locator (URL) to a mobile electronic device so that the URL can be used to navigate a user client software such as a web browser to the corresponding resource. Non-limiting examples of a tag generator are a device showing a QR code on its display and an active Near Field Communication (NFC) tag generator. The tag generator may be a standalone device as well as a functional part of a larger system. The information encoded into the URL contains a session identifier unique to one interactive session.

In a first embodiment, the information from the tag generator includes a sequence-based parameter encoded into the URL as a compound part of the session identifier or as a separate parameter. The server checks the ordering of the requests. Every subsequent request is expected to be newer than the requests serviced before. Otherwise, it is rejected with or without error notification. That sequence-based parameter may be but not limited to a timestamp, a real-time clock time, a free-running counter value, or a sequential number of the session. A sequence-based parameter is also called a sequence number. Sequence numbers need not comprise a contiguous sequence of numbers of characters. Sequence number need not increase each time it is used. A sequence number may be generated from a random or pseudo-random sequence, provided that every sequence number is unique with respect to all sequence numbers used by the same vending machine.

In another embodiment, the information from the tag generator includes a time-based parameter encoded into the URL as a compound part of the session identifier or as a separate parameter. The server checks requests for expiration, preventing a URL from being and used later. If the timeout is exceeded, the request is rejected with or without error notification. That time-based parameter may be but not limited to a Unix epoch timestamp, a real-time clock time, a free-running counter value. Alternatively, that information may be a key in a time-based encryption scheme, such as timed-release encryption.

In yet another embodiment, information from the tag generator includes the identifier of the machine, encoded into the URL as a compound part of the session identifier or as a separate parameter. The identifier may be any sequence of characters assigned to the machine, such as but not limited to, a serial number of the machine, a sequential number assigned to the machine when it is first registered with the server, a universally unique identifier (UUID), a random number, or any combination of the above. The machine identifier may or may not be encrypted. The information about all registered machines with their identifiers is stored in a database accessible by the server.

In yet another embodiment, information from the tag generator includes a network address that allows the server to direct data packages to the machine. This information may be but not limited to a Media Access Control (MAC) address or an Internet Protocol (IP, e.g., IPv4, IPv6) address with a port number or any combination.

In yet another embodiment, the information from the tag generator includes data about the state of the machine, encoded into the URL as a compound part of the session identifier or as a separate parameter. A non-limiting example of the state would be the real-time product inventory in a vending machine.

In yet another embodiment, the session identifier is communicated by the tag generator to the server over the network connection every time it is generated. When the mobile electronic device requests the web page, the server uses the session identifier to identify the machine without exposing the machine identifier itself to the mobile electronic device.

In yet another embodiment, the server is remote to the machine and accessible over the network, such as a local network or the internet. In another embodiment, the server is executed on a processor within the machine itself.

In yet another embodiment, the machine contains a wired or wireless communication device such as but not limited to cellular, Wi-Fi, or Ethernet device. The server then transmits the action requests, such as a vending action with a product code, to the machine over a network connection.

In yet another embodiment, the machine contains a scanner such as but not limited to a barcode scanner, a two-dimensional barcode scanner, a QR code scanner, or a camera capable of scanning any of those codes. The server then transmits the action requests by instructing the mobile electronic device to show a code, such as but not limited to a barcode, a two-dimensional barcode, or a QR code on the screen. The user is instructed to present the screen of the mobile electronic device to the scanner on the machine.

In yet another embodiment, the machine has a wireless transceiver, such as but not limited to NFC or Bluetooth transceiver. The server then transmits the action requests by instructing the mobile electronic device to transmit those requests to the machine through a wireless connection such as but not limited to NFC connection or Bluetooth connection. The user may be instructed to hover their device over an NFC transceiver.

In yet another embodiment, a payment interface is embedded into the web page, allowing the user to make an online payment. A payment gateway then authorizes the payment, and the server processes the result of the authorization before the machine is requested to render a service or dispense a purchased item.

In yet another embodiment, the tag generator, a communication device, a processor, and an interface device are installed into a machine as a retrofit kit. The communication device connects the processor to the server through a network connection. The processor is connected to a pre-existing central controller of the machine either directly or through the interface device utilizing available electrical interfaces. The interface device is connected to the processor, the machine's controller, button inputs, and visual feedback outputs (such as Light Emitting Diodes, LCD or other display). The interface device is configured to emulate buttons being pressed and to collect the feedback given to the user by pre-existing output devices. The processor is configured to execute sequences of emulated inputs to the machine and process the outputs from the machine to achieve goals resulting from the user's interactions with the display data or web page. The processor may be additionally configured to emulate a cashless payment device. The processor may be additionally configured to collect telemetry data and report it to the server over the network connection.

Non-limiting examples of a machine that may be incorporated into the system according to the present disclosure include a traditional vending machine, a public washing machine, a carwash, a parking meter, a gas pump, and alike.

### BRIEF DESCRIPTION OF THE DRAWINGS

FIG. 1 is a schematic diagram illustrating a first embodiment of the system arrangement and the purchase process.

FIG. 2 is a block diagram showing elements of the device and method.

FIG. 3 shows exemplary communication formats with the dynamic tag generator information.

FIG. 4 is a flowchart of exemplary tag generator device operation.

FIG. 5 is a flowchart of exemplary server operation.

FIG. 6 shows an exemplary format of data exchange between a server and a vending machine.

FIG. 7 is a schematic diagram illustrating a second embodiment of the system arrangement and the purchase process.

FIG. 8 is an exemplary system diagram incorporating a retrofitted vending machine.

### DETAILED DESCRIPTION

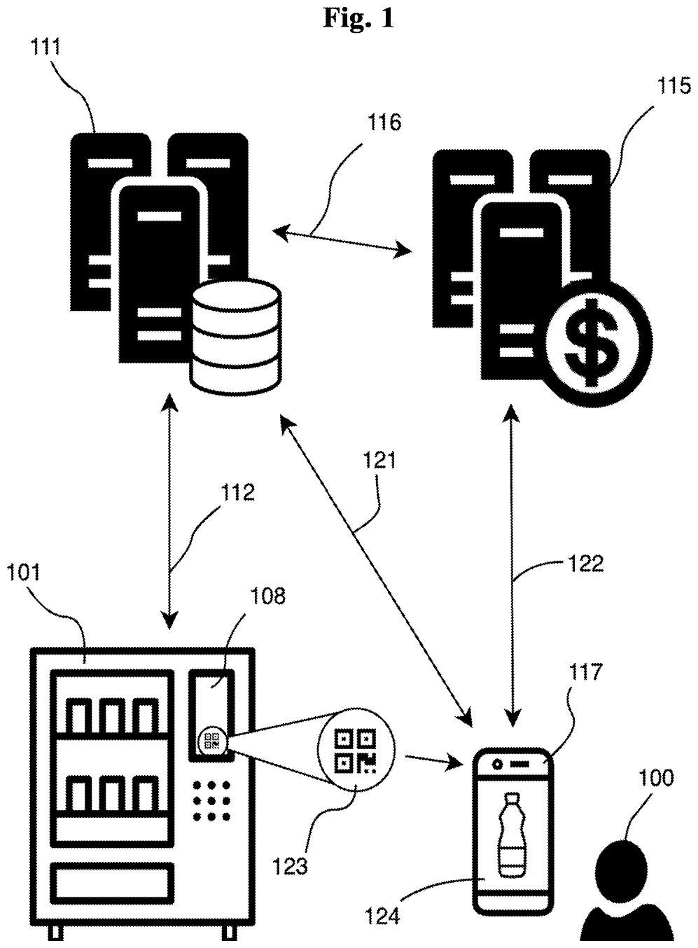

FIG. 1 illustrates a preferred embodiment of a purchase process or method when controlling or using a vending machine with a personal mobile electronic device, such as a smartphone. A user 100 approaches the vending machine 101 and manually scans a QR code 123 from a tag generator 108 with a camera in or associated with their mobile electronic device 117. The mobile electronic device requests a web page or display data 124 unique to the vending machine from a server 111, such as over a network connection 121. User 100 interacts with the display data 124 to learn about the inventoried products and select a product to vend. After the user 100 selects a product, the server 111 receives a product request from the mobile electronic device 117. The server 111 then requests the checkout from a payment gateway 115, such as over a network connection 116. The server 111 facilitates redirection of the mobile electronic device 117 to a checkout interface provided by the payment gateway 115, such as over a network connection 122. After payment is processed, the mobile electronic device 117 is redirected to another display page provided by the server 111, such as over the network connection 121. The payment gateway 115 notifies the server 111 about the successful payment. The server 111 then requests the vending machine 101 to vend (i.e., dispense) the selected product, such as over a network connection 112. The vending machine 101 then receives a vending action with a product code from the server 111, vends (i.e., dispenses) the product, and notifies the server 111 about a successful vend operation. The server 111 then notifies the mobile electronic device 117 that the vending session is finished.

If dispensing of the product is unsuccessful, the vending machine 101 notifies the server 111, and the server 111 requests the payment processor 115 to issue a refund.

Manually scanning the QR code with the personal mobile electronic device's camera is a deliberate action that the user must take while holding their device near the machine to claim it for the vending session. This way, the user's proximity to the machine is verified. Some embodiments use NFC tag instead of the QR code tag to accomplish the same goal. In this case, the user needs to hold or move their device near the displayed, dynamic tag for it to be machine-read.

The QR code or other tag is unique, either globally or for that particular vending machine. In this way, the same tag cannot be used for more than one vending session.

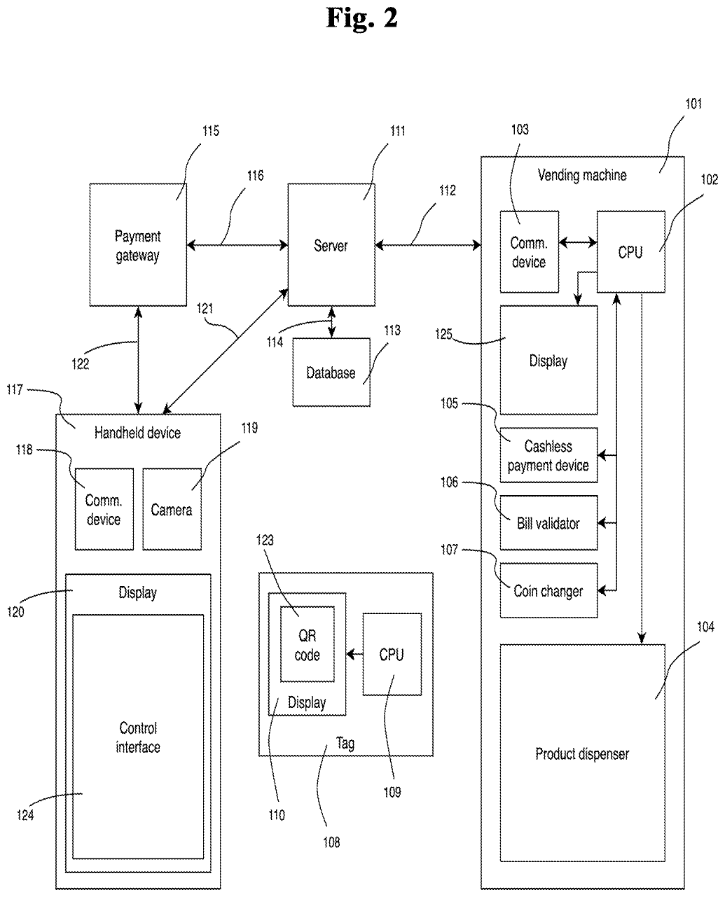

FIG. 2 shows the system diagram of the vending system, according to a preferred embodiment of the present disclosure. The vending machine 101 contains a processor 102, connected to a communication device 103, to a product dispenser 104, to one or more cashless payment devices 105, to a bill validator 106, and a coin changer 107. The tag generator device 108 contains a processor 109 connected to a display 110. The server 111 is connected to the vending machine 101, such as over the network connection 112, through the communication device 103. The server 111 is also connected to a local or remote database 113 over an interface 114. The server 111 is further connected to the payment gateway 115, such as over the network connection 116. Mobile electronic device 117 contains a communication device 118, a camera 119, and a display 120. The mobile electronic device 117 is capable of communicating to the server 111 and the payment gateway 115 over the network

connections 121 and 122 correspondingly, using the communication device 118. The vending machine 101 may additionally have at least one display 125 connected to the processor 102.

The processor 109 within the tag generator 108 generates dynamic information containing a session identifier. The identifier is then included in a web URL pointing to a resource on the server 111. The URL is encoded into a QR code 123 that is shown on the display 110. The display 110 is positioned such to be visible to the user.

The user of the mobile electronic device 117 activates the camera 119 and uses it to scan the QR code 123 from the display 110. The software on the mobile electronic device 117 reads the URL from the QR code 123 and opens a client software such as a mobile web browser to request the corresponding resource from the server 111, such as over the network connection 121.

When the server 111 receives the request from the mobile electronic device 117 it extracts and validates the session identifier. Then it extracts the identifier of the vending machine 101 and retrieves the information associated with the machine from the database 113. The server then produces a web page with the display data 124 matching the configuration and the state of the machine and provides it to the client software on the mobile electronic device 117. The client software then presents the web page on the display 120 as the display data 124 for the vending machine 101. The display data 124 may also comprise elements for user selection or input.

The user can interact with elements of the display data 124 to view additional information about the products inventoried by the vending machine 101. When those interactions happen, additional information may be transmitted between the mobile electronic device 117 and the server 111 as necessary. The user can select a product to be purchased. After the selection, the server 111 receives a product request from the mobile electronic device 117. It then requests the checkout from a payment gateway 115, such as over a network connection 116, and redirects the client software on the mobile electronic device 117 to a web page provided by the payment gateway 115. The client software then exchanges information with the payment gateway 115, such as over the network connection 122, to facilitate the payment process. After finishing the payment, the payment gateway 115 redirects the client software on the mobile electronic device 117 to another web page provided by the server 111.

After payment is received, the payment gateway 115 notifies the server 111 about the payment, such as over the network connection 116. The server 111 then generates a vending action for the machine to dispense the product and transmits the request over the network connection 112. The processor 102 in the vending machine 101 receives the vending action with a product code from the server 111, such as over the network connection 112 through the communication device 103. The processor 102 interprets the request and executes it to dispense the product using the product dispenser 104. The processor 102 then notifies the server 111 about a successful or unsuccessful product dispensing. The server, in turn, generates the notification for the user and transmits it to the mobile electronic device 117, such as over the network connection 121.

If the product dispensing was not successful, the server 111 requests the payment gateway 115 to issue a refund.

The user may be additionally presented with an option to pay for their purchase on the machine 101. In this case, when the user requests the checkout, no redirection to a page provided by the payment gateway 115 happens. Instead, the server 111 generates a vending action to the machine to process payment first and then dispense the product. The processor 102 in the vending machine 101 receives the request from the server 111. The processor 102 interprets the request and waits for the user to make payment using the cashless payment device 105, the bill validator 106, the coin changer 107, or some combination of those. The processor 102 may or may not use any additional displays or other output devices on the machine 101 to prompt the user to make a payment. When payment is received, the processor 102 activates the product dispenser 104 to dispense the product. The processor 102 then notifies the server 111 about successful or unsuccessful product dispensing. The server, in turn, generates the notification for the user and transmits it to the mobile electronic device 117, such as over the network connection 121.

The server 111 and the processor 102 may impose a timeout on receiving the payment.

The tag generator 108 may be placed on the vending machine 101, near or proximal to the vending machine 101, or combined with any part of the vending machine 101. As one example, the processor 109 and the processor 102 may be combined into a single processor. The QR code 123 may be shown on the display 125. Similarly, the tag generator 108 may be combined with one of the cashless payment devices 105.

The database 113 may be of any type, such as but not limited to relational database, NoSQL database, document storage, text file, or any other. The database may contain the information about the real-time product inventory in the vending machine 101, so the product selection may be presented to the user by the server 111 as part of the display data 124. The server 111 may keep track of the real-time inventory and update the database 113 to decrease the inventory every time the product is successfully dispensed.

The processor 102 may notify the server 111 about every transaction in the vending machine accomplished with the cashless payment device 105, the bill validator 106, the coin changer 107, any other available payment method, or without payment. The server 111 may use the notifications to update the database 113 with real-time inventory changes. The server 111 may also write into the database 113 an audit log of all transactions.

The processor 102 may additionally notify the server 111 about any events related to the vending machine 101, such as but not limited to operational failures. The server may store the events in the database 113 and also notify the machine operator when the machine needs service. The database 113 may contain additional information about the products, such as but not limited to product images, detailed description, ingredients, and nutritional information. The server 111 may present this information in the display data 124 along with any additional information from external sources.

In some embodiments of the present disclosure, the payment gateway 115 is combined with the server 111, and the payment interface is directly embedded into the display data 124. In such a case, no redirection to the payment interface is necessary.

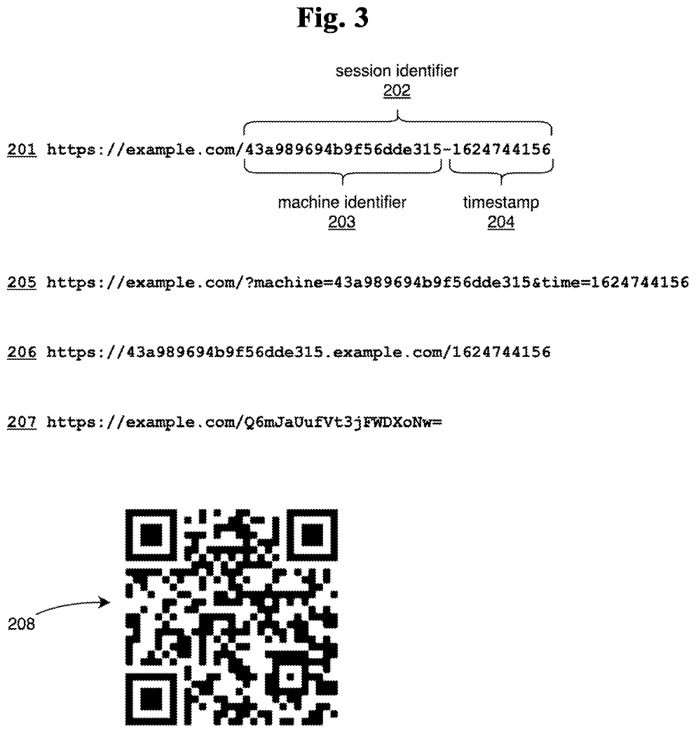

FIG. 3 shows examples of the URL that can be presented on the tag generator. URL 201 contains a compound session identifier 202 within the URL path section. The identifier comprises the machine identifier 203 and the timestamp 204. Here, the timestamp is the Unix epoch time at the moment when the tag was generated. Alternatively, the timestamp may be replaced with a value of a free-running counter, a sequential number of the generated tag, or any other unique identifier.

URL 205 shows the session identifier encoded as key-value pairs within the query section of the URL.

In URL 206, the machine identifier part of the session identifier is encoded as a subdomain.

In URL 207, the session identifier is encoded according to the Base64 encoding scheme for efficiency. 208 is a QR code representation of the URL 207.

Any part of the session identifier may be encrypted for security purposes. Authentication of the URL by the server is preferred, but optional.

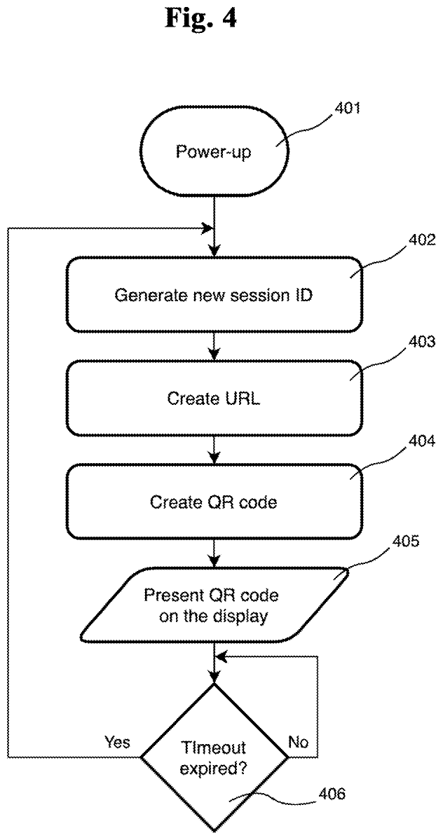

FIG. 4 shows an operational sequence of the processor 109 within the tag generator 108. After the power-up 401, the processor 109 generates a new session identifier at step 402. In the preferred embodiment of the present disclosure, the session identifier comprises a machine identifier and the Unix epoch time as a timestamp. The timestamp part may undergo optional security encryption with any appropriate encryption algorithm, such as those well known in the art. Encryptions may include error checking, such as parity, or error correction, such as Reed Solomon codes. An example of appropriate encryption is the Advanced Encryption Standard (AES). Encryption may also include authentication. Next, at step 403, the processor 109 creates a URL with the domain name of the server 101 and the session identifier. At this step, the session identifier may be encoded according to Base64 or another appropriate scheme to get a compact sequence of characters suitable for inclusion into a URL. Once the URL is created, it is encoded as a QR code at step 404. At step 405, the QR code is presented on the display 110, comprising a generated tag. After that, at step 406, the processor 109 waits for an expiration of a pre-configured timeout to repeat the whole process from step 402.

In some embodiments, QR codes or other machine-readable codes are encrypted. Public key encryption may be used; however, this encryption method requires dissemination of public and private keys, and so is not a preferred embodiment as of the filing date. Tags may include public keys, for either the vending machine, the vending company, or the user, in any combination.

In an alternative embodiment, if the precise time information is not available to the processor 109, a value of a free-running counter may be used instead. In such a case, a counter may be battery-backed, allowing it to keep counting in the event of power interruption.

Alternatively, a sequentially increasing number may be used for every new session identifier. The last number may be stored by the processor 109 in a non-volatile memory to withstand the power interruption.

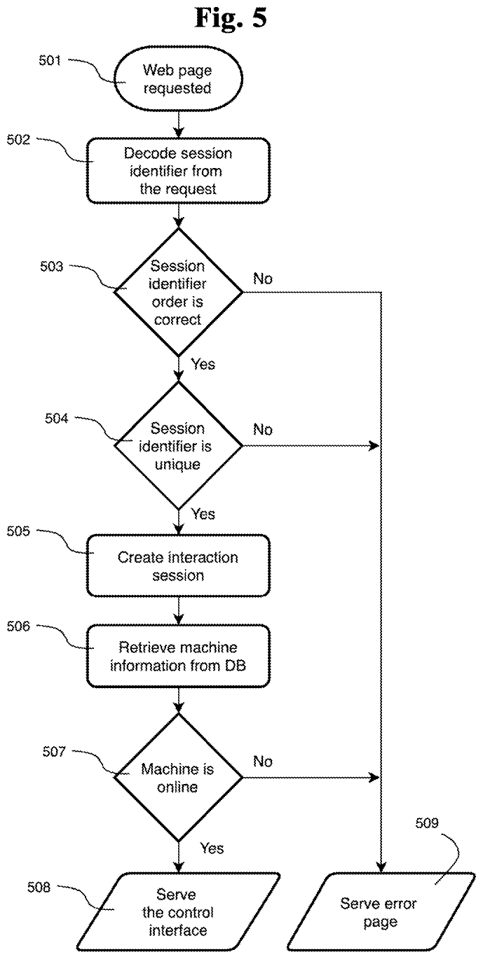

FIG. 5 shows an operation cycle performed by the server 111 upon receiving a new request for a web page from the mobile electronic device 117. The cycle starts at step 501 when the server 111 receives a request for a web page with the URL generated by the processor 109. First, on step 502, the server 111 decodes the session identifier from a transport encoding such as Base64 and separates the machine identifier 203 and the timestamp 204 parts. Next, on step 503, the server 111 checks if the session identifier has the correct order based on the timestamp 204. The order is considered correct if the timestamp 204 falls within the expected range of values around the current time. The range accounts for an acceptable delay between the session identifier being generated by the processor 109 and the request being sent by the mobile electronic device 117. The range may further account for the inaccuracy of the internal clock of the processor 109. After the ordering is verified, on step 504, the server 111 queries the database 113 to verify the uniqueness of the session identifier. If the session with the same identifier is not found, the identifier is considered to be unique, and the server then proceeds to step 505 to create a new interaction session by adding a record to the database 113. Then on step 506 the server 111 retrieves from the database 113 the information specific to the machine 101 identified by the machine identifier 203 in the URL. The server 111 then checks the online status of the machine by comparing the time of the last heartbeat communication received from the machine to the present time. If the machine 101 is online, the server 111 proceeds to step 508 and serves the web page comprising the display data 124 to the mobile electronic device 117.

The display data 124 is specific to the machine 101 identified by the machine identifier 203. Therefore, it may vary depending on the type of the machine, its individual settings, and the real-time product inventory.

If at step 503 it was determined that the session identifier is of wrong order, or at step 504 it was determined that the session identifier is not unique, the server transitions to step 509 and serves the error page to the mobile electronic device 117. The server also proceeds to step 509 if at step 507 it was determined that the machine 101 is offline. There may be other reasons, not shown in the figure, for the server to serve the error page instead of the display data 124. The content of the error page may vary based on a specific error reason.

In alternative embodiments that use a value of a free-running counter instead of the Unix epoch time, at step 503, the server 111 retrieves from the database 113 the offset between the time-base of the tag generator processor 109 and real time. In another embodiment, if the sequential numbering is used instead of the timestamp, the server 111 additionally retrieves the previous valid value for the machine 101 identified by the machine identifier 203 from the database 113. The server then checks that the new value is larger than the previous value. Finally, depending on the particular implementation, steps 503 and 504 may be reordered or combined.

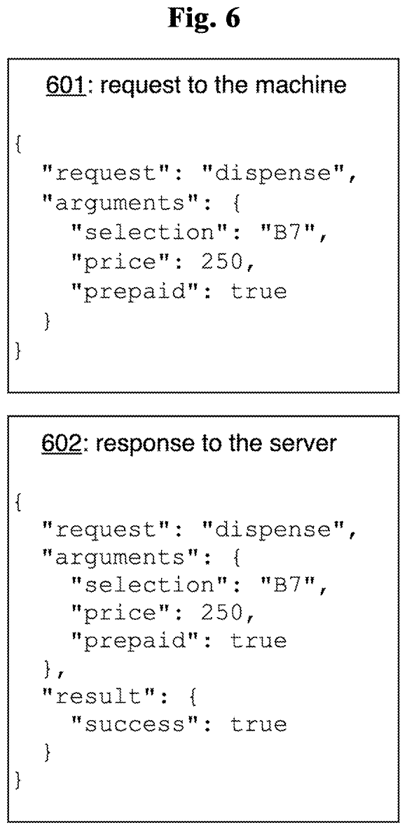

FIG. 6 shows an example of the data exchange between the server 111 and the vending machine 101. The request 601 in JSON format specifies the vending action, the product code, the product price in cents, and the prepaid flag. A prepaid flag indicates to the machine 101 that the payment has been processed through the payment gateway 115, and the product is to be dispensed immediately. If the prepaid flag is set to false, the machine 101 is waiting for the payment to be made with the bill validator 106, the coin changer 107, the cashless payment device 105, or a combination of everything above before the product is dispensed.

The response 602 replicates the parameters from the request 601 and indicates the successful vending.

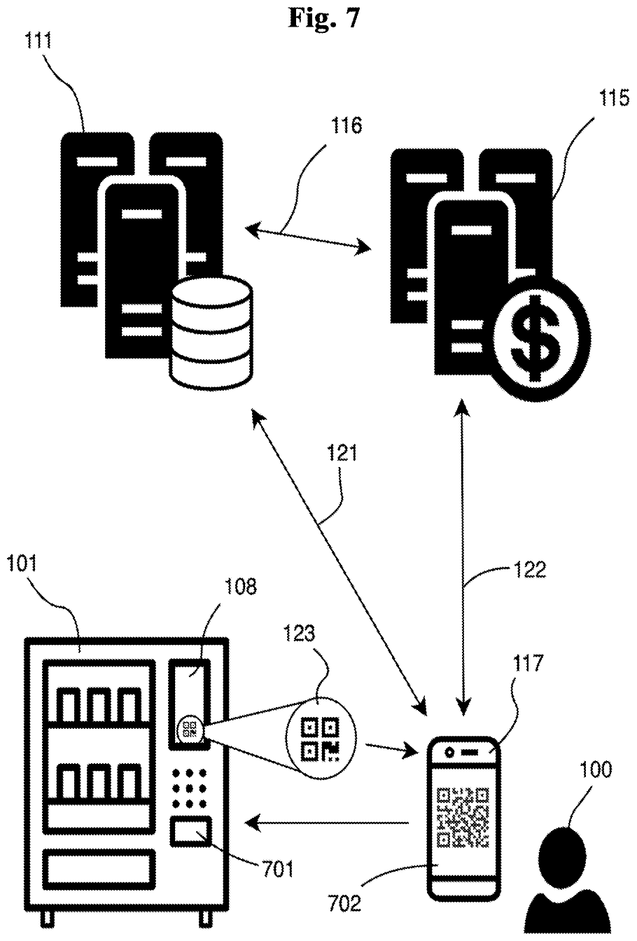

FIG. 7 illustrates a system arrangement and a purchase process when controlling a vending machine with a mobile electronic device, according to an alternative embodiment of the present disclosure. Adding a code reader 701 to the vending machine 101 allows eliminating the network connection 112 between the vending machine 101 and the server 111.

To initiate the purchase, in one embodiment, the user 100 approaches the vending machine 101 and manually scans the QR code 123 from the tag generator 108 with the camera in or associated with their mobile electronic device 117. Additionally, to the session identifier 202, the URL in the QR code 123 comprises the identification of the real-time product inventory in the machine 101. The mobile electronic device requests a web page from the server 111, such as over the network connection 121, using the URL from the QR code 123. When the server 111 receives the request, it first decodes the information about the real-time product inventory from the URL. It then generates a web page, for example, comprising the display data 124 representing the run-time inventory in the vending machine 101. The user 100 then interacts with the display data 124 to learn about the products and select a product for checkout. When a product is selected, the server 111 receives a product request from the mobile electronic device 117. The server 111 then requests the checkout from the payment gateway 115, such as over the network connection 116. The server facilitates redirection of the mobile electronic device 117 to the checkout interface provided by the payment gateway 115, such as over the network connection 122. After payment is processed, the mobile electronic device 117 is redirected to another page provided by the server 111, such as over the network connection 121. The payment gateway 115 notifies the server 111 about the successful payment. The server 111 then generates a securely encrypted vending code 702 comprising a product code and a vending action for the vending machine 101 to dispense the product. Next, the vending code 702 is transmitted to the mobile electronic device 117. The user 100 demonstrates the vending code 702 from the display of the mobile electronic device 117 to the code reader 701 placed on the vending machine 101. The vending machine 101 receives the product code by optically reading the vending code 702 from the display of the mobile electronic device 117 and dispenses the product.

Disambiguation of both users and vending machines is accomplished with the steps and elements of disclosed methods and systems. See above disclosure for FIG. 1 for discussion of disambiguation.

For a preferred embodiment, a user performs two manual steps with their smartphone or other personal mobile electronic device.

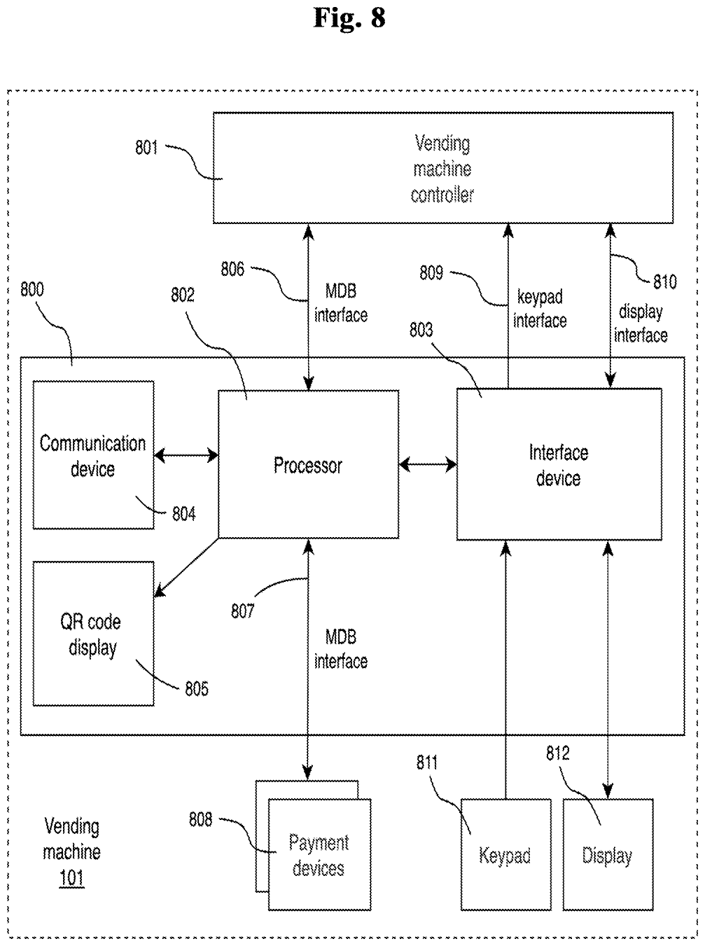

FIG. 8 shows a system diagram of the vending machine 101 with a retrofit device 800 for controlling the vending machine 101 with a personal mobile electronic device 117 according to the present disclosure. The retrofit device 800 is connected to the vending machine controller 801, payment devices 808, a keypad 811, and a vending machine display 812. The retrofit device 800 comprises a processor 802, an interface device 803, a communication device 804, and a QR code display 805. The processor 802 is configured to communicate to the vending machine controller 801 over an MDB interface 806 and emulate peripheral payment devices. On the other hand, the processor 802 is also configured to communicate over a second MDB interface 807 with the peripheral payment devices 808 and emulate a vending machine controller. The processor 802 is further configured to conduct the functions of the tag generator 108 and show QR codes on the display 805. The processor 802 is further configured to communicate to the server 111 through the communication device 804. The processor 802 is further configured to control the interface device 803. The interface device 803 is connected to the vending machine controller 801 over a keypad interface 809 and a display interface 810. The interface device 803 is also connected to the keypad 811, and the vending machine display 812.

When the processor 802 receives a product code and a vending action to dispense a prepaid product such as the request 601, it first communicates a credit to the vending machine controller 801 over the MDB interface 806. The processor 802 then emulates the position selection corresponding to the product code on the keypad interface 809 with the help of the interface device 803.

When the processor 802 receives a product code and a vending action to dispense a product without the prepaid flag being set, it first waits for the peripheral payment devices 808 to establish a credit over the MDB interface 807 and then communicates the credit to the vending machine controller 801 over the MDB interface 806. The processor 802 then emulates the position selection corresponding to the product code on the keypad interface 809 with the help of the interface device 803.

After emulating the position selection, the processor 802 waits for the vending machine controller 801 to report the result of the vend. The processor 802 then reports the result to the server 111.

The processor 802 is also configured to communicate every purchase transaction reported on the MDB interface 806 to the server 111. The server 111 uses that data for audit and real-time inventory tracking.

The processor 802 is also configured to report detectable failures of the vending machine 101 to the server 111 for remote diagnostics. It is further configured to communicate the state of the display 812 collected from the display interface 810 with the help of the interface device 803 to the server 111, allowing remote control and diagnostics.

In further embodiments, a dynamic tag may be audible instead of visible. In such embodiments, an audio signal comprises digital data consistent with the data described in this disclosure for a dynamic tag. The personal mobile electronic device then uses a microphone and suitable software to listen to, decode, and respond to the audio presented by the vending machine. Note that a short-range audio signal still permits disambiguation of multiple users and multiple vending machines, a nexus feature of embodiments. “Proximal,” for such embodiments, means functionally within a suitable distance to detect and decode the audible tag signal. In such embodiments, a vision-impaired user is able to use vending machines. In such embodiments, product selection by a user may be done with audio communication. For example, rather than “displaying” products on the personal electronic device, the product description would be machine read to the user. Voice recognition, for example, may be used for the user to communicate with the personal electronic device. Claims and embodiments should be construed to include such audible, rather than visible, implementation.

### Definitions

“Application” or “App”—in relation to personal mobile electronic devices is a piece of software executable by a mobile electronic device and designed to accomplish a specific goal, e.g., buying products from a vending machine. An application needs to be downloaded and installed on the device before it can be used.

“Disambiguation,” “disambiguate”—a method to uniquely identify a person, device, or data, from a different person, device or data, where they might otherwise conflict. For example, two people attempting to use the same vending machine at the same time. As a second example, one person proximal to more than one vending machine, as is common when there are multiple vending machines side-by-side.

“Dispensing”—a vending machine providing a vended product, requested by a user, to the user. The vended product may be associated with the vending machine and may be a specific service, such as a car wash. Vouchers and cards may be a vended product, wherein the voucher or card provides a remote or future service, such as cell-phone minutes, boarding pass, luggage check, discount coupon, a pre-paid shipping, or a pre-paid meal served remotely. A dispensed product may be a physical item such as a can, bottle, or card. A dispensed product may be a quantity of a liquid, such as coffee, car-wash water, or shower water. Another name for “dispense” is “vend.” Another name for “dispensing” is “vending.”

“MDB”—Multi-Drop Bus, a standardized communication bus and interface(s) typically used inside a vending machine. MDB should be construed broadly to include any standardized communication used by or in vending machines, vending machine equipment, or vending accessories.

“Proximal”—in the context of embodiments of this invention, a user is “proximal” to a personal electronic device when the user may functionally read a screen of the device and functionally control the device. “Functionally read,” for this definition, includes audio communication and other methods of a user to communicate with a personal electronic device if the user is, for example, reading impaired. In the context of embodiments of this invention, a personal electronic device is proximal to a vending machine when the personal electronic device is functionally close enough to the vending machine that an optical sensor, such as a camera, in the personal electronic device, is able to machine-read a dynamic tag presented by the vending machine.

A user is “proximal” to a vending machine when the user is functionally close to the vending machine. For example, being able to readily take a vended product. For many vending machines, a proximal user is able to functionally see one or more products available to vend. For products that are not readily visible, a proximal user is able to functionally read type on the face of the vending machine.

“Product code”—data that uniquely identifies a product to a vending machine. Here, “product” refers to a specific type of product, such as “12-oz can of Pepsi Diet Cola,” rather than one specific can. A product code may include a location in a vending machine, such as a coil ID. Different vending machines will typically have different product codes, even for the same product, such as a “12-oz can of Pepsi Diet Cola.” Product codes may comprise a Universal Product Code (UPC) or product SKU, or a proprietary code.

“QR code,” “barcode,” or “matrix code” is machine-readable, visible code, such as may be read by a camera on a personal electronic device. A “dynamic” code is one that may be altered dynamically, such as generated by a processor and displayed on a display device. Embodiments use an electronic code, which may not be optically visible, providing the equivalent purpose as a dynamic, visible code. Such codes may be single-use, associated with a specific transaction or sale. Such codes may be encrypted. Such codes may be human-readable.

“Real-time inventory” or “real-time product inventory”—is the list of the products that can be immediately dispensed by a vending machine.

“Receiving”—term wherein a receiving device receives data from a sending device. Such data may be transmitted directly between the sending device and the receiving device, or more typically, the receiving is via one or more intermediary devices, such as switches, routers, access points, optical communication, cellular communication, reflectors, relays, personal electronic devices, and the like.

“Server”—is broadly construed as a term in the art, typically a piece of computational hardware or a virtual portion of computational hardware, usually on a communication network. The term also refers to a piece of software that provides functionality to “client” software by servicing its requests.

“Session” or “vending session”—is a time or functional sequence associated with a single transaction or a grouped in time a series of transactions by a single user. Sessions are typically unique. A “transaction” is typically a selection by a single user and then vending, dispensing or enabling the selected product or service. Some transactions may involve more than one product or service, yet are a single selection by a user. A “session” may be such a single transaction or may include a group of sequential transactions for or by a single user.

“Tag generator”—A tag generator an element capable of displaying or transmitting a unique tag to a user. Non-limiting examples of a tag generator are a device showing a QR code on its display and an active Near Field Communication (NFC) tag generator. The tag generator may be a standalone device or an element of an embodiment.

“Tag”—A tag comprises machine-readable data associated with a specific transaction, purchase, session, or a portion thereof. A tag may also be human-readable. In a preferred embodiment, a tag is presented in a QR code or functional equivalent, readable by a camera and associated processor and software in a personal electronic device. A tag may comprise a URL. A tag may comprise a session identifier. A tag may comprise data to direct a user, or a transaction of a user or portion thereof, to remote data or communication resource, such as a web page. A tag is typically unique to a session.

“URL”—means “Uniform Resource Locator,” to be additionally construed as any standardized communication or data format for locating and accessing a server, file, or data path on a network. It may comprise a host name, a domain name, MAC address, IPv4 or IPv6 address, and other data.

“User”—is broadly construed as a person using embodiments of this invention. An alternative name for a user is a customer. A user may also be construed as a device, such as a personal electronic device, being operated by a human in the capacity of a human user or customer using embodiments of this invention.

“Vending action”—an action for a vending machine such as “vend” or “refund.” A vending action may comprise information such as audio to play (e.g., “thank you”) or images to display on a screen, such as additional recommended products or advertisements. A “vending action” may be a physical action by the vending machine, or it may be data or a command to perform an associated physical vending action. Another name for “vend” is “dispense.”

“Vending machine”—means a physical machine that dispenses a specific product or specific service, upon payment or payment method, on demand, typically by a user. Typical products vended include: beverages, snacks, meals, liquids, debit or access cards, vouchers, labels, tokens, insurance, cables, batteries, tools, ice, water, travel tickets, travel convenience items, books, gasoline or other fuel, car washes, showers, rest or sleeping pods, and the like.

“Web page”—an interactive document provided by a server and displayed to a user of mobile electronic device in a client software such as a web browser. One special type of a functionally-rich web page is known as “Progressive Web Application” (PWA).

Ideal, Ideally, Optimal and Preferred—Use of the words, “ideal,” “ideally,” “optimum,” “should,” and “preferred,” when used in the context of describing this invention, refer specifically to the best mode for one or more embodiments for one or more applications of this invention. Such best modes are non-limiting and may not be the best mode for all embodiments, applications, or implementation technologies, as one trained in the art will appreciate.

All examples are sample or exemplary embodiments. In particular, the phrase “invention” should be interpreted under all conditions to mean “an embodiment of this invention.” Examples, scenarios, and drawings are non-limiting. The only limitations of this invention are in the claims.

May Could, Option, Mode, Alternative and Feature—Use of the words “may” “could,” “option,” “optional,” “mode,” “alternative,” “typical,” “ideal,” and “feature,” when used in the context of describing this invention, refer specifically to various embodiments of this invention. Described benefits refer only to those embodiments that provide that benefit. All descriptions herein are non-limiting, as one trained in the art appreciates.

Embodiments of this invention explicitly include all combinations and sub-combinations of all features, elements, and limitations of all claims. Embodiments of this invention explicitly include all combinations and sub-combinations of all features, elements, examples, embodiments, tables, values, ranges, and drawings in the specification and the drawings. Embodiments of this invention explicitly include devices and systems to implement any combination of all methods described in the claims, the specification, the abstract, and the drawings. Embodiments of the methods of this invention explicitly include all combinations of dependent method claim steps, in any functional order. Embodiments of the methods of invention explicitly include, when referencing any device claim or limitation thereof, to any and all other device claims, including all combinations of elements in device claims. Claims for devices and systems may be restricted to perform only the methods of embodiments or claims.

What is claimed is:

1. A method of controlling a vending machine with a proximal mobile electronic device comprising the steps:
(a) generating by a tag generator a dynamic tag unique to a vending session, wherein the dynamic tag comprises a URL;
(b) presenting the dynamic tag to the proximal mobile electronic device;
(c) accessing a remote server, by the proximal mobile electronic device, using the dynamic tag;
(d) transmitting, from the remote server, display data unique to the vending machine; wherein the display data is consistent with the real-time product inventory in the vending machine;
(e) displaying, on the proximal mobile electronic device, the display data;
(f) receiving, by the remote server, a product request for a product, from the proximal mobile electronic device; wherein the product is displayed by the display data;
(g) receiving, by the vending machine, from the remote server, a product code associated with the product in the real-time product inventory;
(h) receiving, by the vending machine, from the remote server, a vending action associated with the product in the real-time product inventory;
(i) dispensing, by the vending machine, the product; wherein: the method is free of a requirement for a user to download an associated application (“App”) to the proximal mobile electronic device.

2. The method of claim 1, wherein: the URL comprises identification of the real-time product inventory in the vending machine.

3. The method of claim 1, wherein:
the receiving, by the vending machine, from the remote server, the product code associated with the product in the real-time product inventory, is via the proximal mobile electronic device.

4. The method of claim 3, wherein:
the receiving, by the vending machine, from the remote server, a product code associated with the product in the real-time product inventory, is via optically reading, by the vending machine, displayed on the proximal mobile electronic device, a vending code.

5. The method of claim 1 wherein:
the display data is a web page.

6. The method of claim 1 wherein:
the dynamic tag is unique with respect to all other dynamic tags used by embodiments of this invention.

7. The method of claim 1 wherein:
the dynamic tag comprises a sequence number that is not repeated for any other dynamic tag used by the vending machine.

8. A system comprising: a vending machine, a tag generator, and a server; wherein
the system is configured to implement, in conjunction with a proximal mobile electronic device, the steps of claim 1.
